(19) United States
(12) Patent Application Publication
(10) Pub. No.: US 2020/0254894 A1
(43) Pub. Date: Aug. 13, 2020

(54) METHOD FOR OPERATING AN INDUCTIVE TRANSMISSION DEVICE

(71) Applicant: Robert Bosch GmbH, Stuttgart (DE)

(72) Inventors: Bernhard Mader, Kernen (DE); Ulrich Brenner, Moeglingen (DE)

(21) Appl. No.: 16/647,987

(22) PCT Filed: Aug. 15, 2018
(86) PCT No.: PCT/EP2018/072107

§ 371 Date: Mar. 17, 2020

(30) Foreign Application Priority Data
Sep. 21, 2017 (DE) 10 2017 216 726.2

(51) Int. Cl. B60L 53/39; G05D 1/02; G05D 1/03; B60L 53/36; B60L 53/12

(52) U.S. Cl. CPC B60L 53/39; G05D 1/0261; G05D 1/03; G05D 2201/0213; B60L 53/36; B60L 53/12; G05D 1/0225

(57) ABSTRACT

The present invention relates to a method for operating an inductive transmission apparatus comprising a transmitting coil and a receiving coil, wherein the receiving coil is arranged in a vehicle and the transmitting coil is arranged in a fixed location, wherein the following steps are carried out: emission of a magnetic field by the transmitting coil; movement of the vehicle in the direction of a parking position, wherein the receiving coil at least partially overlaps the transmitting coil in the parking position; measurement of a magnetic flux linkage of the receiving coil; reduction in a speed of the vehicle when a first threshold value for the magnetic flux linkage through the receiving coil is exceeded; detection of undershooting of a second threshold value; detection of a point without effective magnetic flux linkage through the receiving coil.

### BACKGROUND OF THE INVENTION

The present invention relates to a method for operating an inductive transmission device.

When wirelessly charging the electrical energy stores of electrically driven vehicles by means of the inductive transmission of electric power, transmission systems are used that consist of a transmission coil and a reception coil. To this end, the transmission coil of a charging station is placed onto the road surface, for example using a flat winding, or recessed into the road. The reception coil, having a winding that is as flat as possible, is fitted to the vehicle floor. For the charging process, the vehicle is positioned over the transmission coil. The efficiency of these systems for wireless power transmission by means of a magnetic field, which induces an electric current in the reception coil from the transmission coil, is highly dependent on the correct orientation of the transmission coil and the reception coil. When the orientation is very good, an optimum coupling factor is obtained between the transmission coil and the reception coil. Just small deviations from the ideal orientation result in a significant drop in the efficiency of the transmission between the transmission coil and the reception coil. This has an associated large effect on the system efficiency of inductive transmission devices. The transmission of electric power can take place only in one direction from the transmission coil to the reception coil, but energy transmission can also take place in both directions in applicable systems.

For the purpose of inductively charging the electrical energy stores of electrically driven vehicles, the fine positioning of the vehicle having the reception coil relative to the transmission coil is performed by the driver or by means of an automated parking system. When the vehicle is positioned by the driver, he can be assisted by an assistance system, since positioning solely by means of the wits and skills of the driver does not normally lead to optimum orientation of the transmission coil and the reception coil. Additionally, the geometric design of the coils allows an increased positional tolerance to be attained. It is thus possible for the requirement of positional accuracy transversely with respect to the direction of travel to be expanded, for example, while the positional tolerance in the direction of travel can be chosen to be narrow to achieve an optimum coupling factor on the basis of the simpler positioning of the vehicle by means of forward and backward motion.

When the driver is assisted by an assistance system, improved positioning accuracy is achieved. However, this requires additional measurement systems, which give rise to additional costs and need to be suitable for rough use with motor vehicles. By way of example, DE 10 2014 215 350 A1 proposes a system that comprises a receiver coil arrangement on the vehicle, said receiver coil arrangement capturing three magnetic field components of the magnetic field of the transmission coil by measurement. The captured magnetic field components and the phase relationships pertaining to the electrical AC signal are evaluated by an evaluation device such that fine positioning information is available. The fine positioning information is ascertained as an intersection of the coarse position information, which has or results in the position information of the receiver coil arrangement relative to the transmission coil arrangement.

Furthermore, DE 10 2015 106 317 A1 proposes a transmission coil that comprises an arrangement with a guiding light. This at least one electrical light-emitting element is used to indicate the position of the electromechanical transmission element. As a result of an electrical light-emitting element being arranged on a surface of the baseplate, the position of the baseplate and of the electromagnetic transmission element arranged therein can be detected by a driver of a motor vehicle even in poor lighting conditions and poor weather conditions, which means that precise positioning of the motor vehicle on the baseplate or over the electromagnetic transmission element and associated effective transmission of electromagnetic energy is possible. The at least one light-emitting element is connected to a control unit that activates the light-emitting element when a vehicle approaches and deactivates it again after positioning has taken place. Furthermore, a control unit is used to associate sensing of the ambient light, said sensing being used to control the intensity of the light power of the light-emitting element on the basis of the detected ambient light.

When positioning inductive transmission devices in particular on electrically driven vehicles, it is accordingly necessary either to accept insufficient efficiency or to provide costly technical assistance systems. Even the complex technical assistance systems are limited to appropriately equipped transmission partners and are therefore not useful for any transmission coils and are reliant on the precision of the positioning of the vehicle by means of the wits and skills of the driver.

Since it is desirable for electrically driven vehicles to be able to be provided in very robust and user-friendly fashion but also very inexpensively, there is the need for a positioning device that can perform precise positioning without limitations regardless of the equipment of the transmission partner, for example even at publicly accessible charging stations for electrically driven vehicles, when there are no additional means for positioning available there.

### SUMMARY OF THE INVENTION

The method according to the invention has the advantage that a positioning device is provided that can perform precise positioning without limitations regardless of the equipment of the transmission partner, for example even at publicly accessible charging stations for electrically driven vehicles, when there are no additional means for positioning available there.

According to the invention, to this end there is provision for a method for operating an inductive transmission apparatus consisting of a transmission coil and a reception coil, wherein the reception coil is arranged in a vehicle and the transmission coil is arranged at a fixed location, comprising, in a first step, transmitting a magnetic field by means of the transmission coil, while, in a second step, the vehicle moves in the direction of a parking position. The parking position is characterized in that the reception coil covers at least part of the transmission coil in the parking position. In a third step, the magnetic flux passing through the reception coil is measured. In a fourth step, the velocity of the vehicle is reduced when a first threshold value for the magnetic flux passing through the reception coil is exceeded. In a fifth step, it is detected when a second threshold value for the magnetic flux passing through the reception coil is undershot. In a sixth step, a point without effective magnetic flux passing through the reception coil is detected. The detection of the point without effective magnetic flux passing through the reception coil has the advantage that this point allows a waymark to be provided for positioning an electrically driven vehicle without further additional means for positioning. Reducing the velocity when the first threshold value is exceeded has the advantage that the vehicle can be stopped when reaching the parking position at the point at which the inductive transmission apparatus consisting of a transmission coil and a reception coil is optimally oriented, in order to park at this point during the charging process. This advantageously results in there being positioning information available that allows precise positioning without limitations at charging stations for electrically driven vehicles without further additional means for positioning exclusively with the available components of the inductive transmission device.

The measures cited in the dependent claims allow advantageous developments of the method specified in the independent claim.

Advantageously, the transmission coil is arranged on or in the floor, on or in a wall or on or in a ceiling. In an advantageous manner, the positioning method according to the invention can be used for any coil arrangement. This means that for example the degrees of freedom for the design of electrically driven vehicles are not limited. The transmission coils arranged on or in a wall or on or in a ceiling advantageously do not need to be designed to withstand the stresses that occur when being driven over, for example. Additionally, it is advantageous that there is no need for special resilience against dirt from the road and aggressive media such as for example road salt.

It is particularly advantageous that, following detection of the point without effective magnetic flux passing through the reception coil, the vehicle is moved on by a distance up to the point of optimum orientation and is stopped when the point at which the inductive transmission apparatus consisting of a transmission coil and a reception coil is optimally oriented is reached. This means that a simple distance measurement advantageously results in the vehicle being moved easily and robustly to the point of optimum orientation and stopped there in order to park at this point during the charging process.

Alternatively, following detection of the point without effective magnetic flux passing through, the vehicle can be moved on in the direction of travel until a second point without effective magnetic flux passing through is reached. During the movement of the vehicle, a distance measurement is performed between the two points without effective magnetic flux passing through and the vehicle is stopped when the second point without effective magnetic flux passing through is reached. By halving the measured distance and reversing the vehicle contrary to the direction of travel by half the measured distance and stopping the vehicle after half the measured distance, the point at which the inductive transmission apparatus consisting of a transmission coil and a reception coil is optimally oriented is reached. This means that a distance measurement available in each vehicle advantageously results in the vehicle being moved easily and robustly to the point of optimum orientation and stopped there, in order to park at this point during the charging process.

Advantageously, the point without effective magnetic flux passing through the reception coil is detected from the undershooting of the second threshold value of the magnetic flux passing through the reception coil, a change of arithmetic sign of the gradient of the change in the magnetic flux passing through the reception coil and the exceeding of a third threshold value for the magnetic flux passing through the reception coil. The simple and robust detection of the points without effective magnetic flux passing through the reception coil without further tools is particularly advantageous.

It is advantageous to detect the second point without effective magnetic flux passing through the reception coil from the undershooting of the third threshold value of the magnetic flux passing through the reception coil, a change of arithmetic sign of the gradient of the change in the magnetic flux passing through the reception coil and the exceeding of a second threshold value of the magnetic flux passing through the reception coil. One great advantage is that simple and robust detection of the point without effective magnetic flux passing through the reception coil without further tools is likewise available for detecting the second point without effective magnetic flux passing through the reception coil.

It is beneficial to query the interval between the two points without effective magnetic flux passing through the reception coil from a database and to compare the value ascertained by the distance measurement with the value queried from the database, in order to repeat the parking process in the event of a difference that exceeds a fourth threshold value. It is therefore advantageously possible to detect inadequately precise positioning transversely with respect to the direction of travel of the vehicle by using simple and robust detection of the points without effective magnetic flux passing through the reception coil without further tools.

### BRIEF DESCRIPTION OF THE DRAWINGS

Further features and advantages of the present invention will become evident to a person skilled in the art from the description that follows of exemplary embodiments, which are not intended to be interpreted as restricting the invention, however, with reference to the accompanying drawings.

In the drawings:

FIG. 1: shows a schematic depiction of the method according to the invention,

FIG. 2: shows a schematic depiction of the method according to the invention,

FIG. 3: shows a schematic depiction of the method according to the invention,

FIG. 4: shows a schematic depiction of an electrically driven vehicle having an inductive transmission system, consisting of a transmission coil and a reception coil,

FIG. 5: shows a schematic depiction of the field of a transmission coil and the velocity of the vehicle until it is at a standstill in the parking position when a point without effective magnetic flux passing through the reception coil is used,

FIG. 6: shows a schematic depiction of the field of a transmission coil and the velocity of the vehicle until it is at a standstill in the parking position when two points without effective magnetic flux passing through the reception coil are used.

### DETAILED DESCRIPTION

All the figures are merely schematic depictions of the method according to the invention or of an exemplary embodiment of a vehicle equipped according to the invention. In particular intervals and magnitude relationships are not reproduced to scale in the figures. Corresponding elements are provided with the same reference numerals in the various figures.

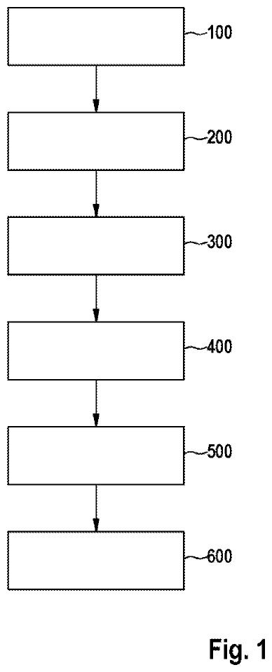

FIG. 1 shows a schematic depiction of the method according to the invention. In the first step 100, a magnetic field 15 is transmitted by the transmission coil 11. In the second step 200, the vehicle 13 moves in the direction of the parking position 16. In the third step 300, the magnetic flux passing through the reception coil 12 is measured. The vehicle 13 moves on unchanged in this step 300. In the fourth step 400, the exceeding of the first threshold value S1 of the magnetic flux passing through the reception coil is detected. In this step 400, the velocity of travel of the vehicle 13 is reduced to the extent that the vehicle 13 can be stopped when the point P3 is reached. In the fifth step 500, the undershooting of the second threshold value S2 of the magnetic flux passing through the reception coil 12 is detected. The vehicle 13 moves on unchanged in this step 500. In the sixth step 600, the point P1 without effective magnetic flux passing through is detected.

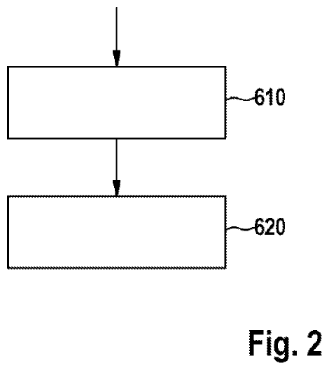

FIG. 2 shows a schematic depiction of the method according to the invention, which follows the method shown in FIG. 1. In the first step 610, the vehicle 13 moves on unchanged, while for example wheel sensors are used to record the distance 17 covered between the points P1 and P3. In the second step 620, the distance measurement is used to detect when the distance 17 between the points P1 and P3 has been covered completely, and the vehicle 13 is stopped in its parking position 16 at the point P3 with the maximum effective magnetic flux passing through. The vehicle 13 has then reached the point P3 with the maximum effective flux passing through the reception coil 12 in a correct orientation and can be charged with an optimum coupling factor and hence high efficiency. This likewise applies to bidirectional use of the inductive transmission device for charging the vehicle battery and for feeding back electric power from the vehicle battery to the supply grid. Performing this method requires knowledge of the distance 17 between the points P1 and P3. This information may be present in the vehicle 13 or can be communicated to the vehicle 13 by the transmission coil 11 by means of a suitable communication device.

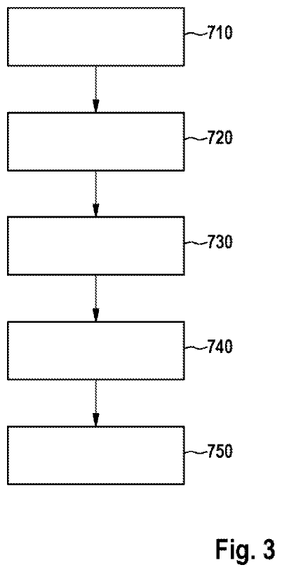

FIG. 3 shows a schematic depiction of the method according to the invention, which follows the method shown in FIG. 1. In the first step 710, the vehicle 13 moves on unchanged, while for example wheel sensors are used to record the distance 18 covered between the points P1 and P2. In the second step 720, the exceeding of the third threshold value S3 of the magnetic flux passing through the reception coil 12 is detected. The vehicle 13 moves on unchanged in this step 720. In the third step 730, the undershooting of the third threshold value S3 of the magnetic flux passing through the reception coil 12 is detected. The vehicle 13 is slowed down from the detection of the third threshold value S3 in this step 730. In the fourth step 740, a second point P2 without magnetic flux passing through the reception coil 12 is detected. The vehicle is stopped. The distance 18 between the points P1 and P2, which is ascertained between the first point P1 without magnetic flux passing through the reception coil 12 and the second point P2 without magnetic flux passing through the reception coil 12, is halved and the distance 19 between the points P2 and P3 is ascertained. In the fifth step 750, the vehicle 13 reverses contrary to the direction of travel by this distance 19 between the points P2 and P3 and is stopped at the point P3 with the maximum effective magnetic flux passing through. This means that the vehicle 13 has reached the point P3 with the maximum effective flux passing through the reception coil 12 in the correct orientation and can be charged with an optimum coupling factor and hence high efficiency. This method is particularly suitable if there is no information available about the distance 17 between the points P1 and P3. This method can be used by the vehicle 13 itself to ascertain this distance 17 between the points P1 and P3 by driving over the transmission coil 11 completely. Furthermore, by driving over the transmission coil 11 completely when the distance 18 between the points P1 and P2 is known, the vehicle 13 can ascertain the lateral offset between the transmission coil 11 and the reception coil 12. If the distance measurement of the distance 18 between the points P1 and P2 by the vehicle 13 results in a value whose absolute value of the difference from the communicated or known value of the distance 18 exceeds a threshold value S4, the lateral offset between the transmission coil 11 and the reception coil 12 is too great and a new parking process for the vehicle 13 at the inductive charging station 10 can be initiated.

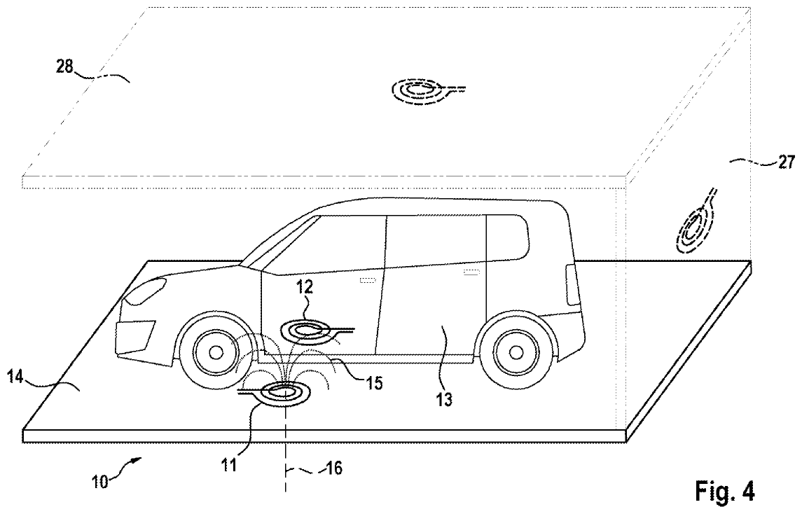

FIG. 4 shows a schematic depiction of a vehicle 13 having an inductive charging device 10. The vehicle is standing on a floor area 14. This floor area 14 has a recessed inductive transmission coil 11 for charging the electrical energy store of the vehicle 13. In a further embodiment, the transmission coil 11 may have been placed onto the floor area 14. The underside of the vehicle 13 has the reception coil 12 fitted, which, during a charging process, needs to be positioned in the parking position 16 with as correct an orientation as possible above the transmission coil 11 in order to achieve an optimum coupling factor and hence a good system efficiency for the inductive charging apparatus 10. The vehicle 13 and hence the reception coil 12 can be oriented above the transmission coil 11 by the driver without further tools. The vehicle 13 is oriented in the transverse direction usually by the driver. Together with a transverse tolerance for the reception coil 12 above the transmission coil 11 that is expanded by design, this is sufficiently accurate. The longitudinal orientation of the reception coil 12 above the transmission coil 11 is more difficult to implement solely by means of the wits and skills of the driver and cannot normally be carried out with sufficient accuracy by the driver without further tools. Further embodiments are obtained by means of the arrangement of the transmission coil 11 on or in a wall 27 or on or in a ceiling 28 and the corresponding arrangement of the reception coil 12 of the vehicle 13.

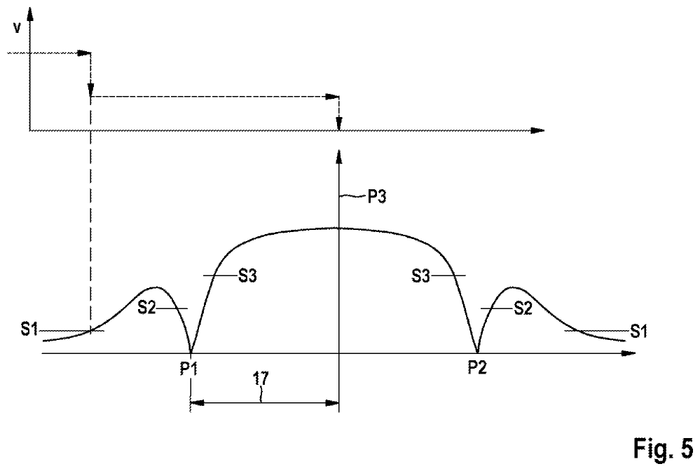

FIG. 5 shows a schematic depiction of the field of a transmission coil 11 and the velocity of the vehicle 13 up until it is at a standstill when a point P1 without effective magnetic flux passing through the reception coil 12 is detected. In this depiction, the vehicle 13 approaches the transmission coil 11 from the left. When the exceeding of the first threshold value S1 is detected, the velocity of travel of the vehicle 13 is reduced. Following detection of the undershooting of the second threshold value S2 and detection of the point P1 without effective magnetic flux passing through the reception coil 12, the distance measurement of the distance 17 between the points P1 and P3 is started from the point P1 without effective magnetic flux passing through the reception coil 12. Following complete coverage of the distance 17 between the points P1 and P3, the vehicle 13 is stopped in its parking position 16 at the point P3 with the maximum effective magnetic flux passing through the reception coil 12 and is parked for the charging process.

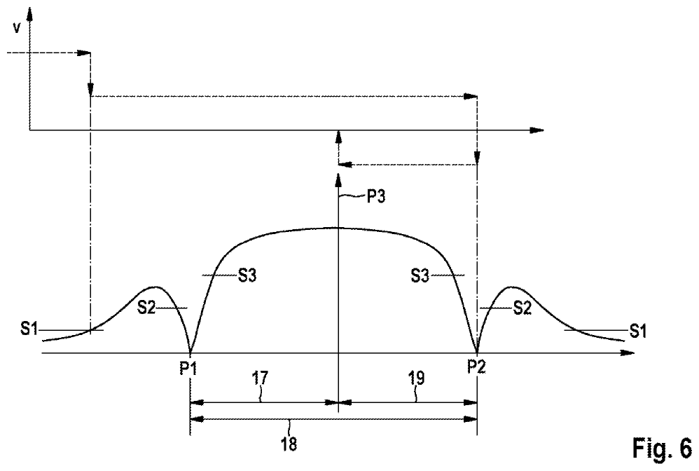

FIG. 6 shows a schematic depiction of the field of a transmission coil 11 and the velocity of the vehicle 13 up until it is at a standstill when a point P1 without effective magnetic flux passing through the reception coil 12 is detected. In this depiction, the vehicle 13 approaches the transmission coil 11 from the left. When the exceeding of the first threshold value S1 is detected, the velocity of travel of the vehicle 13 is reduced. From when the point P1 without effective magnetic flux passing through the reception coil 12 is detected, the distance measurement of the distance 18 between the points P1 and P2 is started. When the second point P2 without effective magnetic flux passing through the reception coil 12 is detected, the vehicle is stopped and the measured distance 18 is halved by computer. The vehicle 13 reverses contrary to the direction of travel by the distance 19 thus ascertained between the points P2 and P3 by the distance 19 between the points P2 and P3 and is stopped at the point P3 with the maximum effective magnetic flux passing through the reception coil 12 and is parked for the charging process. This means that the vehicle 13 has reached the point P3 with the maximum effective magnetic flux passing through the reception coil 12 in the correct orientation and can be charged with an optimum coupling factor and hence high efficiency. If the value for the distance 18 between the points P1 and P2 is known, a comparison between the measured value of the distance 18 between the points P1 and P2 and the value of the distance 18 that is known from a database 31 can be performed. If the difference between the measured distance 18 and the distance 18 known from a database 31 is greater than a fourth threshold value S4, the vehicle 13 has been positioned above the transmission coil 11 with too great a lateral offset and a new parking process for the vehicle 13 at the inductive transmission apparatus consisting of a transmission coil and a reception coil can be initiated.

1. A method for operating an inductive transmission apparatus (10) including a transmission coil (11) and a reception coil (12), wherein the reception coil (12) is arranged in a vehicle (13) and the transmission coil (11) is arranged at a fixed location,
the method comprising:
transmitting a magnetic field (15) by means of the transmission coil (11);
moving the vehicle (13) in the direction of a parking position (16), wherein the reception coil (12) covers at least part of the transmission coil (11) in the parking position (16);
measuring a magnetic flux passing through the reception coil (12);
reducing a velocity of the vehicle (13) when a first threshold value (S1) for the magnetic flux passing through the reception coil (12) is exceeded;
detecting when a second threshold value (S2) is undershot; and
detecting a point (P1) without effective magnetic flux passing through the reception coil (12).

2. The method as claimed in claim 1, wherein the transmission coil (11) is arranged in the floor (14), in a wall (27) or in a ceiling (28).

3. The method as claimed in claim 1,
wherein
the vehicle (13) is moved in the direction of travel by a distance (17) from the point (P1) without effective magnetic flux passing through to the point (P3) at which the transmission coil (11) and the reception coil (12) are optimally oriented with respect to one another, and the vehicle (13) is stopped when a parking position (16) at the point (P3) at which at least part of the reception coil (12) is covered by the transmission coil (11) is reached.

4. The method as claimed in claim 1,
wherein
the vehicle (13) is moved in the direction of travel and at the same time the distance covered is measured and a second point (P2) without effective magnetic flux passing through the reception coil (12) is detected during the movement of the vehicle (13) and the vehicle (13) is stopped when the second point (P2) without effective magnetic flux passing through the reception coil (12) is reached and a distance (18) covered between point (P1) and point (P2) is ascertained, and the distance (19) to be covered contrary to the direction of travel up to the parking position (16) is calculated by halving the distance (18) and the vehicle (13) is moved contrary to the direction of travel by the distance (19) from the second point (P2) without effective magnetic flux passing through to the parking position (16) in which at least part of the reception coil (12) is covered by the transmission coil (11) at the fixed location.

5. The method as claimed in claim 1 for detecting the point (P1) without effective magnetic flux passing through the reception coil (12),
wherein
the undershooting of a second threshold value (S2) for the magnetic flux passing through the reception coil (12) is detected, the change of arithmetic sign of the gradient of the magnetic flux passing through the reception coil (12) is detected and the exceeding of a third threshold value (S3) for the magnetic flux passing through the reception coil (12) is detected.

6. The method as claimed in claim 4 for detecting the point (P2) without effective magnetic flux passing through the reception coil (12),
wherein
the undershooting of the third threshold value (S3) of the magnetic flux passing through the reception coil (12) is detected, the change of arithmetic sign of the gradient of the magnetic flux passing through the reception coil (12) is detected and the exceeding of the second threshold value (S2) of the magnetic flux passing through the reception coil (12) is detected.

7. The method as claimed in claim 4,
wherein
the interval (31) between the point (P1) and the point (P2) of the transmission coil (11) is queried from a database (30), the ascertained distance (18) is compared with the interval (31) ascertained from the database (30) and a difference (32) is ascertained, and the parking process is repeated if a fourth threshold value (S4) is exceeded by the magnitude of the difference (32).
